(19) United States
(12) Patent Application Publication
(10) Pub. No.: US 2026/0265623 A1
(43) Pub. Date: Sep. 10, 2026

(54) PROCESS FOR PRODUCING ONE OR MORE GASES FROM SOLID WASTE MATERIAL IN A LANDFILL SITE

(71) Applicant: BASE SE, Ludwigshafen am Rhein (DE)

(72) Inventors: Todd M. GASIOROWSKI, Freeport, TX (US); Samantha Au GEE, Houston, TX (US); Paul-Vinzent STROBEL, Ludwigshafen am Rhein (DE); Thomas HORST, Ludwigshafen am Rhein (DE); Thomas William MCKAY, Wyandotte, MI (US); Kevin Scott TODD, Lake Jackson, TX (US)

(21) Appl. No.: 19/167,993

(22) PCT Filed: Mar. 22, 2024
(86) PCT No.: PCT/EP2024/057745

§ 371 Date: Sep. 23, 2025

(30) Foreign Application Priority Data
Mar. 24, 2023 (EP) 23164045.9

(51) Int. Cl. C10J 3/46

(52) U.S. Cl. CPC C10J 3/463; C10J 2300/0906; C10J 2300/0946; C10J 2300/0953; C10J 2300/1612

(57) ABSTRACT

The present invention relates to a process for producing one or more gases from solid waste material and a production unit for producing one or more gases from solid waste material.

The present invention relates to a process for producing one or more gases from solid waste material and a chemical production unit for producing one or more gases from solid waste material.

As to worldwide waste disposal, landfilling represent the typical method for managing the waste material. For example, in the USA, nearly 150 million tons of waste material are sent to landfills. Landfill gas (LFG), also called biogas, are produced from anaerobic decomposition of carbon-containing waste. Said landfill gases comprises in majority methane and carbon dioxide as well as impurities, such as other gases and/or pollutants. The production of methane in these landfills worldwide has pronounced environmental impacts, in particular the proper recovery of LFG is of high importance for the climate (greenhouse gases). This is in particular disclosed in U.S. Pat. No. 7,198,433 B2 which describes a method of collecting landfill gas from a landfill.

However, there is a high demand to improve the waste material management in order to provide recycled carbon feedstocks and reduce the carbon footprint.

Therefore, the present invention relates to a process for producing one or more gases from solid waste material W in a landfill site comprising a sorting zone Z_{S} and a gas-producing zone Z_{G},
the process comprising
   (i) a first stage S1 comprising:
      (i.1) sorting the solid waste material W, which comprises organic waste material including wood waste material and organic waste material other than wood waste material, and inorganic waste material including plastic waste material and inorganic waste material other than plastic waste material, in the sorting zone Z_{S}, wherein (i) comprises
         (i.1.1) sorting the solid waste material W in a sorting unit SU1 comprised in Z_{S}, obtaining a mixture M1 comprising the organic solid waste material and a mixture M2 comprising the inorganic solid waste material;
         (i.1.2) sorting the mixture M1 obtained according to (i.1.1) in a sorting unit SU2 comprised in Z_{S}, with SU2 being located downstream of SU1, obtaining a mixture M11 comprising the wood waste material and a mixture M12 depleted in wood waste material compared to M1 comprising the organic waste material other than wood waste material;
   (ii) a subsequent stage S2 comprising:
      (ii.1) introducing M11 obtained according to (i), as a feed stream F11, into a gasifier in the gas-producing zone Z_{G} and bringing in contact F11 to one or more gasification components in the gasifier, obtaining a stream F1 comprising one or more gases;
   (iii) a subsequent stage S3 comprising:
      (iii.1) collecting the mixture M12 obtained according to (i.1.2) in an anaerobic digestion unit in the gas-producing zone Z_{G} and subjecting M12 to anaerobic digestion conditions, obtaining a stream F2 comprising one or more gases.

According to the present invention, it has been shown that one could improve the waste management directly in landfills (the process of the present invention is performed at landfill sites) by using further sorting, gasification of organic waste material already present or being transported to landfills. In particular, the present invention permits to improve the rate of production of landfill gas thanks to the subsequent removal of wood waste material as it increases the surface area of waste and speeds the ability of the anaerobic bacteria to digest the incoming feedstock. Further, thanks to the gasifier, the process according to the present invention produces syngas (synthetic gases, namely CO, H₂) which renders the whole concept of landfill even more valuable. Finally, since the installation of an additional sorting unit, gasifier and methanation unit can be done directly at the landfills, it permits also to reduce costs as equipment already present in the landfills, such as connection to the gas grid or cleaning equipment, can be also used for the produced syngas.

The production of one or more gases according to the process of the present invention can be done in landfill sites which already comprise an anaerobic digestion unit and a sorting unit (SU1). Indeed, this permits to reduce costs for implementing the process of the present invention. Hence, in order to implement the process, one would need to only add a gasifier for the gasification of the wood waste material and an additional sorting unit on already existing landfill site. The existing connection to the grid can be used and it is conceivable that similar purification units as described in the following can be used both after gasification in the gasifier and the anaerobic digestion.

In the context of the present invention, the term “landfill site” refers to a landfill site in the sense given by the skilled person in the art, in particular it refers to a site for the disposal of waste materials. In the present invention, the site comprises a sorting zone Z_{S} and a gas-producing zone Z_{G}, the presence of a sorting zone in particular for wood waste is completely novel and inventive and permits a more efficient recycling treatment.

Preferably, sorting according to (i.1.1) is a mechanical or manual sorting.

Preferably, the sorting unit SU1 comprises one or more of magnets, screens, sieves, detection units, and conveyors.

Preferably, the detection unit(s) comprised in SU1 are infrared sorters.

Preferably, sorting according to (i.1.2) is a mechanical sorting or manual sorting.

Preferably, the sorting unit SU2 comprises one or more of magnets, screens, sieves, detection units, and conveyors.

Preferably, the detection unit(s) comprised in SU2 are infrared sorters.

Optionally the process further comprises prior to S1, providing the solid waste material W which comprises transporting W to the landfill site comprising the sorting zone Z_{S} and the gas-producing zone Z_{G}. Optionally the process further comprises prior to S1, providing the solid waste material W which comprises transporting W to the sorting zone Z_{S} of the landfill site for performing S1.

According to usual processes in the art, the organic waste material is directly fed into the landfill for anaerobic digestion. However, according to the present invention, there is a second sorting step, namely according to (i.1.2), which permits to remove wood waste material from the streams which can be sent to anaerobic digestion. Hence, according to the present invention, without wanting to be bound to any theory this permits to reduce the size of the feedstock fed to anaerobic digestion in landfills which thus permits to increase the surface area of organic waste material other than wood waste material in the landfill and speed up the ability of the anaerobic bacteria to digest the incoming feedstock.

Preferably, S1 further comprises
(i.2) passing the mixture M11 into a storage unit and storing M11 in said storage unit for a period of time Δt;
(i.3) removing M11 from the storage unit prior to (ii).

Preferably, the storage unit used according to (i.2) is one or more of a container and a shed. In the context of the present invention, wood waste material comprised in M11 is preferably stored away from bad weather, such as rain.

Preferably, Δt is in the range of from 1 h to 1 year. It will depend on the quantity of wood waste to be collected. Once a certain amount of wood waste material has been collected, it is then fed into the gasifier.

Preferably, the subsequent stage S2 further comprises, prior to (i.1), subjecting the wood waste material comprised in M11 obtained according to (i) to a pre-treatment, wherein more preferably the pre-treatment comprises one or more of shredding, cutting, pelletizing, milling, crushing, and drying, preferably one or more of shredding, cutting, pelletizing and drying, the wood waste material comprised in M11. More preferably, the subsequent stage S2 further comprises, prior to (i.1), subjecting the wood waste material comprised in M11 obtained according to (i) to a pre-treatment, wherein the pre-treatment comprises shredding, or cutting, in combination with drying the wood waste material comprised in M11. Indeed, the reduction of the waste size permits to improve gasification in the gasifier and the drying to also save energy during gasification. Therefore, such pre-treatment of M11 is very beneficial for the process of the present invention.

Preferably, the average particle size of the wood waste material of M11 introduced into the gasifier according to (ii.1) is in the range of from 0.2 to 500 mm, the average particle size being determined by laser diffraction or light microscopy. These methods being adapted by the skilled person depending on the particle size range. Thus, particle sieve analysis could also be used for determining the average particle size. The average particle size of the wood waste material of M11 will be adapted to the gasifier according to the skilled person knowledge.

Optionally, S2 further comprises removing additional impurities from M11, such as metals and glass.

Preferably at least 70 weight-%, more preferably at least 80 weight-%, more preferably at least 85 weight-% of the wood waste material comprised in M11 consist of wood.

Preferably from 99 to 100 weight-% of M11 consists of the wood waste material.

Preferably, M11 introduced in the gasifier according to (ii.1) has a water content of at most 30 weight-%, more preferably in the range of 1 to 30 weight-%, more preferably in the range of from 1 to 20 weight-%, more preferably in the range of from 1 to 15 weight-%, based on the weight of M11. Examples of methods for determining the water content in wood waste material are disclosed in “Method of determining the moisture content of wood” by Jamie Hartley and John Marchant, Technical paper no. 41, Research division State Forests of New South Wales, Sydney, October 1995.

Preferably, the gasifier is one or more of a fixed bed gasifier, a fluidized bed gasifier, a slag bath gasifier, more preferably one or more of a fixed bed gasifier and a fluidized bed gasifier.

Preferably, the fluidized bed gasifier is a bubbling fluidized gasifier, a circulating fluidized bed gasifier or an entertained flow fluidized bed gasifier.

Preferably, no coal or fossil fuel is introduced into the gasifier used according to (ii.2).

Preferably, the one or more gases comprised in F1 provided according to (ii.1) are one or more of H₂, CO, CO₂ and CH₄, more preferably are H₂, CO, CO₂ and CH₄.

Preferably, the one or more gasification components in the gasifier according to (ii.1) are selected from the group consisting of air, oxygen (O₂), steam (H₂O), carbon dioxide (CO₂) and a mixture of two or more thereof, more preferably are selected from the group consisting of oxygen (O₂), steam (H₂O) and a mixture thereof.

Preferably, oxygen and steam are brought in contact with F1 in the gasifier according to (ii. 1).

Preferably, oxygen and steam are introduced separately in the gasifier according to (ii.1).

Preferably, the molar ratio of steam relative to O₂ is in the range of from 0.05:1 to 5:1, more preferably in the range of from 0.05:1 to 1:1.

In the context of the present invention, bringing in contact M11 to the one or more gasification components in the gasifier according to (ii.1) is performed at any temperature as long as it permits to obtain the one or more gases. The skilled person in the art will know how to adapt this parameter.

Preferably, bringing in contact M11 to the one or more gasification components in the gasifier according to (ii.1) is performed at a temperature in the range of from 500 to 1300° C., more preferably in the range of from 600 to 1200° C. The skilled person in the art will adjust the temperature disclosed within this range based on the gasifier.

Preferably, bringing in contact M11 to the one or more gasification components in the gasifier according to (ii.1) is performed at a pressure in the range of from 0.5 to 50 bar(abs), more preferably in the range of from 1 to 30 bar(abs).

Preferably according to S2, no pyrolysis of M11 is performed prior to the gasification in the gasifier located in the gas-producing zone Z_{G}. Indeed, the wood is directly fed to the gasifier.

Preferably, S2 and S3 are performed simultaneously. Alternatively, preferably, S2 and S3 are performed one after the other in any order.

Preferably, S3 is performed continuously and S2 is performed periodically.

Preferably, the one or more gases comprised in F2 provided according to (iii.1) are one or more of CH₄ and CO₂, preferably CH₄ and CO₂. Therefore, the present invention preferably relates to process for producing one or more gases from solid waste material W in a landfill site comprising a sorting zone Z_{S} and a gas-producing zone Z_{G},
the process comprising
   (i) a first stage S1 comprising:
      (i.1) sorting the solid waste material W, which comprises organic waste material including wood waste material and organic waste material other than wood waste material, and inorganic waste material including plastic waste material and inorganic waste material other than plastic waste material, in the sorting zone Z_{S}, wherein (i) comprises
         (i.1.1) sorting the solid waste material W in a sorting unit SU1 in Z_{S}, obtaining a mixture M1 comprising the organic solid waste material and a mixture M2 comprising the inorganic solid waste material;
         (i.1.2) sorting the mixture M1 obtained according to (i.1.1) in a sorting unit SU2 in Z_{S}, with SU2 being located downstream of SU1, obtaining a mixture M11 comprising the wood waste material and a mixture M12 depleted in wood waste material compared to M1 comprising the organic waste material other than wood waste material;
   (ii) a subsequent stage S2 comprising:
      (ii.1) introducing M11 obtained according to (i), as a feed stream F11, into a gasifier in the gas-producing zone Z_{G} and bringing in contact F11 to one or more gasification components in the gasifier, obtaining a stream F1 comprising one or more of H₂, CO, CO₂ and CH₄, more preferably H₂, CO, CO₂ and CH₄;
   (iii) a subsequent stage S3 comprising:
      (iii.1) collecting the mixture M12 obtained according to (i.1.2) in an anaerobic digestion unit in the gas-producing zone Z_{G} and subjecting M12 to anaerobic digestion conditions, obtaining a stream F2 comprising one or more of CH₄ and CO₂, more preferably CH₄ and CO₂.

In the context of the present invention, preferably, the anaerobic digestion unit used according to (iii.1) comprises one or more closed tanks.

Preferably, the anaerobic digestion of M12 is performed at a temperature in the range of from 5 to 60° C., more preferably in the range of from 10 to 50° C., more preferably in the range of from 20 to 40° C.

In the context of the present invention, the production of one or more gases from the landfill can also be done as disclosed in U.S. Pat. No. 7,198,433 B2.

Preferably, the process of the present invention further comprises
(iv) a subsequent stage S4 comprising
   (iv.1) passing the stream F1 obtained according to (ii) into one or more purification units, obtaining a purified stream F1P comprising one or more gases;
   (iv.2) passing the stream F2 obtained according to (iii) into one or more purification units, obtaining a purified stream F2P comprising one or more gases.

Preferably, (iv.1) comprises
passing the stream F1 obtained according to (ii) into one or more purification units, obtaining a purified stream F1P, depleted in one or more impurities compared to F1.

Preferably, the one or more impurities are one or more of CO₂, N₂, sulfur, H₂O, and volatile organic compounds (VOC).

Preferably, the one or more purification units comprises one or more of a CO₂ removal unit, such as a CO₂ gas separation membrane, an amine absorption unit or Pressure Swing Adsorption (PSA) unit, a sulfur removal unit, a N₂ removal unit, such as a cold box, a VOC removal unit, such as stripping unit or adsorption unit, and a water removal unit, such as a condensation unit.

Examples of sulfur removal units are adsorption units, preferably using activated carbon, iron oxides (such as iron sponge, etc.), absorption/trapping units, preferably amine scrubbing or using iron salts, chelated or no chelated or water or no-water solvents trapping unit (e.g. mixture of dimethyl ethers of polyethylene glycols), biofilters, biotrickling filter, bioscrubber and so on.

Examples of purification units are disclosed in “Report: Biogas and bio-syngas upgrading” of the Danish Technological Institute, December 2012.

Preferably, (iv.2) comprises
passing the stream F2 obtained according to (iii) comprising CH₄ and CO₂ into one or more purification units, obtaining a purified stream F2P, depleted in CO₂ compared to F2, comprising CH₄.

Preferably, F2P has a CO₂ content of at most 0.5 weight-%, more preferably of at most 0.45 weight-%, based on the weight of F1P. Such content being measured by gas sensing devices as known in the art.

Preferably, F2P is substantially free, more preferably free of CO₂.

Preferably, (iv) comprises
(iv.1) passing F1 obtained according to (ii) comprising H₂, CO, CO₂ and CH₄ into one or more purification units PU, obtaining a purified stream F1P, depleted in CO₂ compared to F1, comprising H₂, CO and CH₄;
(iv.2) passing F2 obtained according to (iii) comprising CH₄ and CO₂ into PU, obtaining a purified stream F2P, depleted in CO₂ compared to F2, comprising CH₄; wherein F1 and F2 are, simultaneously or separately, passed through PU.

Preferably, PU comprises a CO₂ removal unit, the CO₂ removal unit being one or more of a CO₂ gas separation membrane, an amine absorption unit and Pressure Swing Adsorption (PSA) unit, preferably PSA unit. An example of PSA process is disclosed in “Carbon Dioxide Capture by Pressure Swing Adsorption” Rafael M. Siqueira, et al., Energy Procedia Volume 114, July 2017, Pages 2182-2192.

Optionally, PU further comprises one or more of a sulfur removal unit, a N₂ removal unit, such as a cold box, a VOC removal unit, such as stripping unit or adsorption unit, and a water removal unit, such as a condensation unit.

Examples of sulfur removal units are adsorption units, preferably using activated carbon, iron oxides (such as iron sponge, etc.), absorption/trapping units, preferably amine scrubbing or using iron salts, chelated or no chelated or water or no-water solvents trapping unit (e.g. mixture of dimethyl ethers of polyethylene glycols), biofilters, biotrickling filter, bioscrubber and so on.

Examples of purification units are disclosed in “Report: Biogas and bio-syngas upgrading” of the Danish Technological Institute, December 2012.

Alternatively, preferably, (iv) comprises
(iv.1) passing F1 obtained according to (ii) into a purification unit PU1, obtaining a purified stream F1P, depleted in one or more impurities compared to F1;
(iv.2) passing F2 obtained according to (iii) comprising CH₄ and CO₂ into a purification PU2, obtaining a purified stream F2P, depleted in CO₂ compared to F2, comprising CH₄;
   wherein PU1 and PU2 are distinct units.

Preferably, the one or more impurities are one or more of CO₂, N₂, sulfur, H₂O, and volatile organic compounds (VOC).

Preferably, PU1 comprises one or more of a CO₂ removal unit, a sulfur removal unit, a N₂ removal unit, a VOC removal unit and a water removal unit.

Preferably, PU2 comprises a CO₂ removal unit, said unit being one or more of a CO₂ gas separation membrane, an amine absorption unit and Pressure Swing Adsorption (PSA) unit, preferably PSA unit. An example of PSA process is disclosed in “Carbon Dioxide Capture by Pressure Swing Adsorption” Rafael M. Siqueira, et al., Energy Procedia Volume 114, July 2017, Pages 2182-2192.

Optionally, PU2 further comprises one or more of a sulfur removal unit, a N₂ removal unit, such as a cold box, a VOC removal unit, such as stripping unit or adsorption unit, and a water removal unit, such as a condensation unit.

Examples of sulfur removal units are adsorption units, preferably using activated carbon, iron oxides (such as iron sponge, etc.), absorption/trapping units, preferably amine scrubbing or using iron salts, chelated or no chelated or water or no-water solvents trapping unit (e.g. mixture of dimethyl ethers of polyethylene glycols), biofilters, biotrickling filter, bioscrubber and so on.

Examples of purification units are disclosed in “Report: Biogas and bio-syngas upgrading” of the Danish Technological Institute, December 2012.

In the context of the present invention, preferably, (iv) further comprises
(iv.3) subjecting F1P obtained according to (iv.1) to methanation conditions in a methanation unit MU, obtaining a stream FP comprising CH₄, wherein the concentration of methane in FP>the concentration of methane in F1P.

Preferably from 95 to 100 weight-%, more preferably from 97 to 100 weight-%, of FP consists of CH₄.

Optionally, (iv.3) further comprises introducing H₂ into the methanation unit. Indeed, this will permit to get the optimal molar ratio of H₂/CO₂, namely about 4:1, in the methanation unit, when methane is produced from CO₂ and H₂ in MU. According to the present invention, methane can also be produced in MU with CO and H₂. Thus, this will permit to get the optimal molar ratio of H₂/CO, namely about 3:1, in the methanation unit, when methane is produced from CO and H₂ in MU. Further, it is conceivable to also adjust those ratios by water shift reaction.

In the context of the present invention, the methanation unit is preferably installed directly at the landfills, it permits also to reduce costs as equipment already present in the landfills, such as connection to the gas grid or cleaning equipment, can be also used for the produced syngas. Thus, the process of the present invention can be implemented at least partially in already existing units present in a landfill site with anaerobic digestion unit, which is cost effective and reduces carbon foot print.

Preferably, the process further comprises
(v) a subsequent stage S5 comprising
   (v.1) sorting the mixture M2 obtained according to (i.1.1), obtaining a mixture M21 comprising plastic waste material and a mixture M22, depleted in plastic waste material compared to M2, comprising inorganic waste material other than plastic waste material;
   (v.2) introducing M21 obtained according to (v.1), as a feed stream F21, into a gasifier in the gas-producing zone Z_{G} and bringing in contact F21 to a feed stream F20 comprising a gasification component in the gasifier, obtaining a stream F3 comprising one or more gases.

Preferably, no coal or fossil fuel is introduced into the gasifier used according to (v.2).

Preferably, the gasification component comprised in F20 is selected from the group consisting of air, oxygen (O₂), steam (H₂O), carbon dioxide (CO₂) and a mixture of two or more thereof, preferably is selected from the group consisting of oxygen (O₂), steam (H₂O) and a mixture of thereof, more preferably a mixture of oxygen (O₂) and steam (H₂O).

Preferably, (v) further comprises after (v.1) and prior to (v.2) sorting the plastic waste material comprised in M21 in a sorting unit SU3. Indeed, prior to entering the gasifier, it is preferred that for example one or more of PVC and PET be removed from M21.

Examples of gasification of plastic waste is disclosed in Gartzen Lopez, et al., “Recent advances in the gasification of waste plastics. A critical overview”, Renewable and Sustainable Energy Reviews 82 (2018) 576-596, Sep. 28, 2017.

Preferably, (v) further comprises
passing F3 obtained according to (v.2) comprising H₂, CO, CO₂ and CH₄ into a purification unit PU3, obtaining a purified stream F3P, depleted in one or more impurities compared to F3.

Preferably, the one or more impurities are one or more of CO₂, N₂, sulfur, H₂O, and volatile organic compounds (VOC).

Preferably, PU3 comprises one or more of a CO₂ removal unit, such as a CO₂ gas separation membrane, an amine absorption unit or Pressure Swing Adsorption (PSA) unit, a sulfur removal unit, a N₂ removal unit, such as a cold box, a VOC removal unit, such as stripping unit or adsorption unit, and a water removal unit, such as a condensation unit.

Examples of sulfur removal units are adsorption units, preferably using activated carbon, iron oxides (such as iron sponge, etc.), absorption/trapping units, preferably amine scrubbing or using iron salts, chelated or no chelated or water or no-water solvents trapping unit (e.g. mixture of dimethyl ethers of polyethylene glycols), biofilters, biotrickling filter, bioscrubber and so on.

Examples of purification units are disclosed in “Report: Biogas and bio-syngas upgrading” of the Danish Technological Institute, December 2012.

Preferably, S2, S3 and S5 are performed simultaneously. Alternatively, preferably S2, S3 and S5 are performed one after the other in any order.

Preferably, S3 is performed continuously, S2 is performed periodically and S5 is performed periodically.

Preferably, the process of the present invention further comprises
(vi) a subsequent stage S6 comprising
   (vi.1) compressing one or more of gases obtained according to one or more of (ii) and (iii), preferably of one or more gases obtained according to (iv) as defined in the foregoing.

Preferably, (vi) further comprises
(vi.2) compressing one or more of gases obtained according to (v).

The present invention further relates to a production unit for carrying out a process for producing one or more gases from solid waste material W in a landfill site, preferably the process according to the present invention,
a sorting zone Z_{S} comprising
   a sorting unit SU1 for sorting solid waste material;
   a sorting unit SU2 for sorting organic solid waste material, SU2 being located downstream of SU1;
a gas-producing zone Z_{G} comprising
   an anaerobic digestion unit for the digestion of solid waste material and the production of one or more gases;
   a gasifier for gasifying carbon-containing solid waste material;
      wherein Z_{S} and Z_{G} are located in the landfill site.

In the context of the present invention, it is preferred that the process of the present invention be implemented on landfill sites which already comprise an anaerobic digestion unit for the digestion of solid waste material and a sorting unit (SU1). Indeed, this permits to save costs by using already existing infrastructures.

Preferably, the production unit of the present invention further comprises one or more of one or more purification units, a compression unit CPU, a methanation unit MU, a means for transporting methane to the gas grid, a gasifier for plastic waste and a sorting unit SU3. Examples of said unit are disclosed in FIGS. 2 and 3.

Preferably, the one or more purification units are as defined in the foregoing.

The present invention further relates to a use of methane obtained or obtainable by a process according to the present invention as feedstock for the gas grid.

The present invention further relates to a process for providing a feedstock for the gas grid, comprising performing the process of the present invention, obtaining a methane feedstock; providing said obtained methane feedstock to the grid.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 3”, every embodiment in this range is meant to be explicitly disclosed for the skilled person, i.e. the wording of this term is to be understood by the skilled person as being synonymous to “The process of any one of embodiments 1, 2 and 3”. Further, it is explicitly noted that the following set of embodiments represents a suitably structured part of the general description directed to preferred aspects of the present invention, and, thus, suitably supports, but does not represent the claims of the present invention.

1. A process for producing one or more gases from solid waste material W in a landfill site comprising a sorting zone Z_{S} and a gas-producing zone Z_{G}, the process comprising
(i) a first stage S1 comprising:
   (i.1) sorting the solid waste material W, which comprises organic waste material including wood waste material and organic waste material other than wood waste material, and inorganic waste material including plastic waste material and inorganic waste material other than plastic waste material, in the sorting zone Z_{S}, wherein (i) comprises
      (i.1.1) sorting the solid waste material W in a sorting unit SU1 in Z_{S}, obtaining a mixture M1 comprising the organic solid waste material and a mixture M2 comprising the inorganic solid waste material;
      (i.1.2) sorting the mixture M1 obtained according to (i.1.1) in a sorting unit SU2 in Z_{S}, with SU2 being located downstream of SU1, obtaining a mixture M11 comprising the wood waste material and a mixture M12 depleted in wood waste material compared to M1 comprising the organic waste material other than wood waste material;
   (ii) a subsequent stage S2 comprising:
      (ii.1) introducing M11 obtained according to (i), as a feed stream F11, into a gasifier in the gas-producing zone Z_{G} and bringing in contact F11 to one or more gasification components in the gasifier, obtaining a stream F1 comprising one or more gases;
   (iii) a subsequent stage S3 comprising:
      (iii.1) collecting the mixture M12 obtained according to (i.1.2) in an anaerobic digestion unit in the gas-producing zone Z_{G} and subjecting M12 to anaerobic digestion conditions, obtaining a stream F2 comprising one or more gases.

2. The process of embodiment 1, wherein sorting according to (i.1.1) is a mechanical or manual sorting.

3. The process of embodiment 1 or 2, wherein the sorting unit SU1 comprises one or more of magnets, screens, sieves, detection units, and conveyors.

4. The process of any one of embodiments 1 to 3, wherein sorting according to (i.1.2) is a mechanical sorting or manual sorting.

5. The process of any one of embodiments 1 to 4, wherein the sorting unit S2 comprises one or more of magnets, screens, sieves, detection units, and conveyors.

6. The process of any one of embodiments 1 to 5, wherein S1 further comprising
(i.2) passing the mixture M11 into a storage unit and storing M11 in said storage unit for a period of time Δt, wherein preferably Δt is in the range of from 1 h to 1 year;
(i.3) removing M11 from the storage unit prior to (ii).

7. The process of any one of embodiments 1 to 6, wherein S2 further comprises, prior to (i.1), subjecting the wood waste material comprised in M11 obtained according to (i) to a pre-treatment, wherein preferably the pre-treatment comprises one or more of shredding, cutting, pelletizing, milling, crushing, and drying, preferably one or more of shredding, cutting, pelletizing and drying, more preferably shredding and drying or more preferably cutting and drying, the wood waste material comprised in M11.

8. The process of any one of embodiments 1 to 7, wherein M11 introduced in the gasifier according to (ii.1) has a water content of at most 30 weight-%, more preferably in the range of 1 to 30 weight-%, more preferably in the range of from 1 to 20 weight-%, more preferably in the range of from 1 to 15 weight-%, based on the weight of M11.

9. The process of any one of embodiments 1 to 8, wherein the gasifier is one or more of a fixed bed gasifier, a fluidized bed gasifier, a slag bath gasifier, preferably one or more of a fixed bed gasifier and a fluidized bed gasifier.

10. The process of any one of embodiments 1 to 9, wherein the one or more gases comprised in F1 provided according to (ii.1) are one or more of H₂, CO, CO₂ and CH₄, preferably are H₂, CO, CO₂ and CH₄.

11. The process of any one of embodiments 1 to 10, wherein the one or more gasification components in the gasifier according to (ii.1) are selected from the group consisting of air, oxygen (O₂), steam (H₂O), carbon dioxide (CO₂) and a mixture of two or more thereof, preferably are selected from the group consisting of oxygen (O₂), steam (H₂O) and a mixture of thereof.

12. The process of embodiment 11, wherein the molar ratio of steam relative to O₂ is in the range of from 0.05:1 to 5:1, preferably in the range of from 0.05:1 to 1:1.

13. The process of any one of embodiments 1 to 12, wherein bringing in contact M11 to the one or more gasification components in the gasifier according to (ii.1) is performed at a temperature in the range of from 500 to 1300° C., preferably in the range of from 600 to 1200° C.

14. The process of any one of embodiments 1 to 13, wherein bringing in contact M11 to the one or more gasification components in the gasifier according to (ii.1) is performed at a pressure in the range of from 0.5 to 50 bar(abs), preferably in the range of from 1 to 30 bar(abs).

15. The process of any one of embodiments 1 to 14, wherein S2 and S3 are performed simultaneously; or wherein S2 and S3 are performed one after the other in any order.

16. The process of any one of embodiments 1 to 15, wherein the one or more gases comprised in F2 provided according to (iii.1) are one or more of CH₄ and CO₂, preferably CH₄ and CO₂.

17. The process of any one of embodiments 1 to 16, wherein the anaerobic digestion unit used according to (iii.1) comprises one or more closed tanks.

18. The process of any one of embodiments 1 to 17, wherein the anaerobic digestion of M12 is performed at a temperature in the range of from 5 to 60° C., preferably in the range of from 10 to 50° C., more preferably in the range of from 20 to 40° C.

19. The process of any one of embodiments 1 to 18, further comprising
(iv) a subsequent stage S4 comprising
   (iv.1) passing the stream F1 obtained according to (ii) into one or more purification units, obtaining a purified stream F1P comprising one or more gases;
   (iv.2) passing the stream F2 obtained according to (iii) into one or more purification units, obtaining a purified stream F2P comprising one or more gases.

20. The process of embodiment 19, wherein (iv.1) comprises
passing the stream F1 obtained according to (ii) into one or more purification units, obtaining a purified stream F1P, depleted in one or more impurities compared to F1.

21. The process of embodiment 19 or 20, wherein (iv.2) comprises passing the stream F2 obtained according to (iii) comprising CH₄ and CO₂ into one or more purification units, obtaining a purified stream F2P, depleted in CO₂ compared to F2, comprising CH₄.

22. The process of embodiment 21, wherein (iv) comprises
(iv.1) passing F1 obtained according to (ii) comprising H₂, CO, CO₂ and CH₄ into a purification unit PU, obtaining a purified stream F1P, depleted in CO₂ compared to F1, comprising H₂, CO and CH₄;
(iv.2) passing F2 obtained according to (iii) comprising CH₄ and CO₂ into said purification PU, obtaining a purified stream F2P, depleted in CO₂ compared to F2, comprising CH₄;
   wherein F1 and F2 are, simultaneously or separately, passed through PU.

23. The process of embodiment 22, wherein PU comprises a CO₂ removal unit, the CO₂ removal unit being one or more of a CO₂ gas separation membrane, an amine absorption unit and Pressure Swing Adsorption (PSA) unit.

24. The process of embodiment 20 or 21, wherein (iv) comprises
(iv.1) passing F1 obtained according to (ii) into a purification unit PU1, obtaining a purified stream F1P, depleted in one or more impurities compared to F1;
(iv.2) passing F2 obtained according to (iii) comprising CH₄ and CO₂ into a purification PU2, obtaining a purified stream F2P, depleted in CO₂ compared to F2, comprising CH₄;
   wherein PU1 and PU2 are distinct units.

25. The process of embodiment 24, wherein PU1 comprises one or more of a CO₂ removal unit, a sulfur removal unit, a N₂ removal unit, a VOC removal unit and a water removal unit.

26. The process of embodiment 24 or 25, wherein PU2 comprises a CO₂ removal unit, said unit being one or more of a CO₂ gas separation membrane, an amine absorption unit and Pressure Swing Adsorption (PSA) unit.

27. The process of any one of embodiments 20 to 26, wherein (iv) further comprises
(iv.3) subjecting F1P obtained according to (iv.1) to methanation conditions in a methanation unit, obtaining a stream FP comprising CH₄, wherein the concentration of methane in FP>the concentration of methane in F1P.

28. The process of any one of embodiments 1 to 27, further comprising
(v) a subsequent stage S5 comprising
   (v.1) sorting the mixture M2 obtained according to (i.1.1), obtaining a mixture M21 comprising plastic waste material and a mixture M22, depleted in plastic waste material compared to M2, comprising inorganic waste material other than plastic waste material;
   (v.2) introducing M21 obtained according to (v.1), as a feed stream F21, into a gasifier in the gas-producing zone Z_{G} and bringing in contact F21 to a feed stream F20 comprising a gasification component in the gasifier, obtaining a stream F3 comprising one or more gases.

29. The process of any one of embodiments 1 to 28, further comprising
(vi) a subsequent stage S6 comprising
   (vi.1) compressing one or more of gases obtained according to one or more of (ii) and (iii), preferably of one or more gases obtained according to (iv) as defined in any one of embodiments 19 to 27.

30. A production unit for carrying out a process for producing one or more gases from solid waste material W in a landfill site, preferably the process according to any one of embodiments 1 to 29,
the production unit comprising:
   a sorting zone Z_{S} comprising
      a sorting unit SU1 for sorting solid waste material;
      a sorting unit SU2 for sorting organic solid waste material, SU2 being located downstream of SU1;
   a gas-producing zone Z_{G} comprising
      an anaerobic digestion unit for the digestion of solid waste material and the production of one or more gases;
      a gasifier for gasifying carbon-containing solid waste material;
         wherein Z_{S} and Z_{G} are located in the landfill site.

31. The production unit of embodiment 30, further comprising one or more of one or more purification units, a compression unit CPU, a methanation unit MU, a means for transporting methane to the gas grid, a gasifier for plastic waste and a sorting unit SU3.

32. A process for providing a feedstock for the gas grid, comprising
performing the process of any one of embodiments 21 to 29, as far as embodiments 22 to 29 depend on embodiment 21, obtaining a methane feedstock; and
providing said obtained methane feedstock to the grid.

It is explicitly noted that the above set of embodiments represents a suitably structured part of the general description directed to preferred aspects of the present invention, and, thus, suitably supports, but does not represent the claims of the present invention.

In the context of the present invention, the term “organic waste material” refers to materials produced mainly from living organisms, either plant or animal. Examples include food waste material, human waste material, sewage, paper waste material, wood waste, manure, green waste, biodegradable plastic, and slaughterhouse waste.

In the context of the present invention, the term “inorganic waste material” refers materials which are not produced from living organisms, either plant or animal, but industrially produced. Examples include plastic waste material, including textile waste material, tire waste material, glass waste material, and metal waste material.

In the context of the present invention, the term “anaerobic digestion” refers to the process where organic matter is broken down by microorganisms in the absence of oxygen. Biogas is generated, namely methane and CO₂. Digestate is also obtained, namely a wet mixture leftover form the anaerobic digestion process and which can be utilized as fertilizer.

In the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C.. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

### DESCRIPTION OF THE FIGURE(S)

FIG. 1 is a schematic representation of a production unit for carrying out a process for producing one or more gases according to the prior art at a landfill site. The production unit comprises a sorting unit SU1, an anaerobic digestion unit ADU, one or more purification units PU and a compression unit CPU. The solid waste material W, which comprises organic waste material including wood waste material and organic waste material other than wood waste material, and inorganic waste material including plastic waste material and inorganic waste material other than plastic waste material, is sorted in SU1 to obtain a mixture M1 comprising the organic solid waste material and a mixture M2 comprising the inorganic solid waste material. M1 is collected in ADU and subjected to anaerobic digestion conditions to obtain a stream F10 comprising one or more gases. F10 is then introduced into PU for removing CO₂ and optionally other impurities such as sulfur, nitrogen, water and/or VOC. F10P comprising methane is obtained and further compressed in CPU prior to be added to the gas grid (GG).

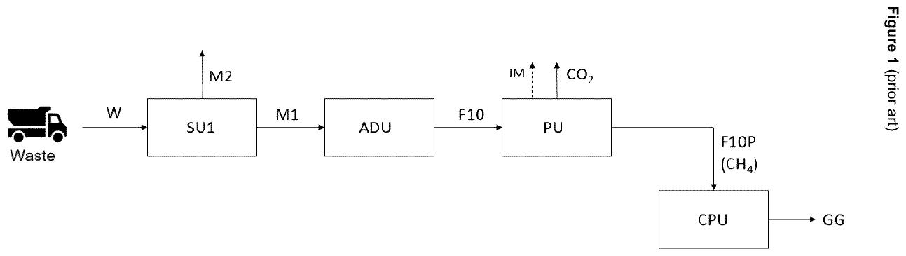

FIG. 2 is a schematic representation of a production unit for carrying out a process for producing one or more gases according to embodiments of the present invention. The production unit comprises a sorting zone Z_{S}, a gas-producing zone Z_{G}, a purification unit PU1, a purification unit PU2, a methanation unit MU and a compression unit CPU. The sorting zone Z_{S} comprises a sorting unit SU1 and a sorting unit SU2 and the gas-producing zone Zo comprises an anaerobic digestion unit ADU and a gasifier GF. The solid waste material W, which comprises organic waste material including wood waste material and organic waste material other than wood waste material, and inorganic waste material including plastic waste material and inorganic waste material other than plastic waste material, is sorted in SU1 to obtain a mixture M1 comprising the organic solid waste material and a mixture M2 comprising the inorganic solid waste material. M1 is further sorted in SU2 obtaining a mixture M11 comprising the wood waste material and a mixture M12 depleted in wood waste material compared to M1 comprising the organic waste material other than wood waste material. M11 is introduced into the gasifier GF, and brought in contact with one or more gasification components CG, preferably O₂ and steam, more preferably O₂ and steam are introduced separately into GF, obtaining a stream F1 comprising one or more gases. M12 is collected in ADU and subjected to anaerobic digestion conditions to obtain a stream F2 comprising one or more gases. F1 is then introduced into PU1 for removing one or more impurities such as CO₂, sulfur, nitrogen, water and/or VOC, obtaining F1P depleted in said one or more impurities. F2 is introduced into PU2 for removing CO₂ and optionally other impurities such as sulfur, nitrogen, water and/or VOC. The obtained stream F1P is introduced into MU, obtaining methane. H₂ can be added when CO₂ is comprised in F1P to obtain optimal CO₂/H₂ ratio to produce methane. The obtained methane is further compressed in CPU prior to be added to the gas grid (GG). The obtained stream F2P, depleted in CO₂, comprising methane is further compressed in CPU prior to be added to the gas grid (GG).

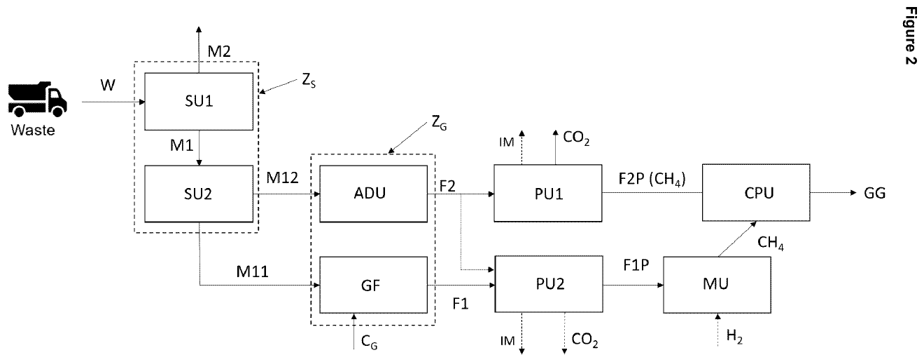

FIG. 3 is a schematic representation of a production unit for carrying out a process for producing one or more gases according to embodiments of the present invention. The production unit comprises a sorting zone Z_{S}, a gas-producing zone Z_{G}, one or more purification units PU, a methanation unit MU and a compression unit CPU. The sorting zone Z_{S} comprises a sorting unit SU1 and a sorting unit SU2 and the gas-producing zone Z_{G} comprises an anaerobic digestion unit ADU and a gasifier GF. The solid waste material W, which comprises organic waste material including wood waste material and organic waste material other than wood waste material, and inorganic waste material including plastic waste material and inorganic waste material other than plastic waste material, is sorted in SU1 to obtain a mixture M1 comprising the organic solid waste material and a mixture M2 comprising the inorganic solid waste material. M1 is further sorted in SU2 obtaining a mixture M11 comprising the wood waste material and a mixture M12 depleted in wood waste material compared to M1 comprising the organic waste material other than wood waste material. M11 is introduced into the gasifier GF, and brought in contact with one or more gasification components C_{G}, preferably O₂ and steam, more preferably O₂ and steam are introduced separately into GF, obtaining a stream F1 comprising one or more gases. M12 is collected in ADU and subjected to anaerobic digestion conditions to obtain a stream F2 comprising one or more gases.

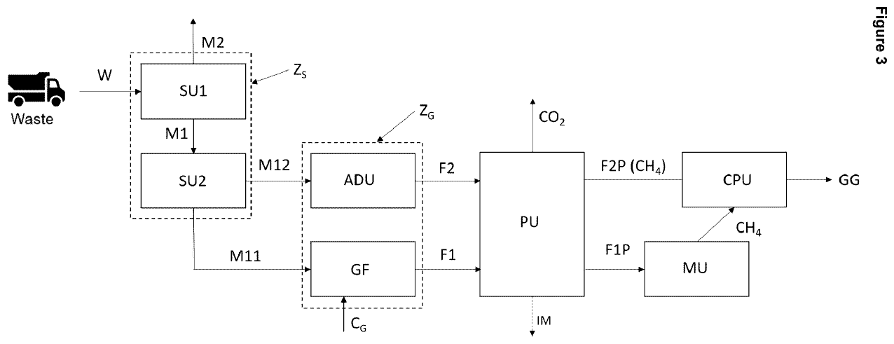

F1 and F2 are then introduced into PU for removing CO₂ and optionally other impurities such as sulfur, nitrogen, water and/or VOC. The obtained stream F1P, depleted in CO₂, comprising CO and H₂ is introduced into MU, obtaining methane which is further compressed in CPU prior to be added to the gas grid (GG). The obtained stream F2P, depleted in CO₂, comprising methane is further compressed in CPU prior to be added to the gas grid (GG).

### CITED LITERATURE

U.S. Pat. No. 7,198,433 B2
“Report: Biogas and bio-syngas upgrading” of the Danish Technological Institute, December 2012
“Carbon Dioxide Capture by Pressure Swing Adsorption” Rafael M. Siqueira, et al., Energy Procedia Volume 114, July 2017, Pages 2182-2192.
Gartzen Lopez, et al., “Recent advances in the gasification of waste plastics. A critical overview”, Renewable and Sustainable Energy Reviews 82 (2018) 576-596, Sep. 28, 2017
“Method of determining the moisture content of wood” by Jamie Hartley and John Marchant, Technical paper no. 41, Research division State Forests of New South Wales, Sydney, October 1995

1.-17. (canceled)

18. A process for producing one or more gases from solid waste material W in a landfill site comprising a sorting zone Z_{S} and a gas-producing zone Z_{G},
the process comprising:
(i) a first stage S1 comprising:
(i.1) sorting the solid waste material W, which comprises organic waste material including wood waste material and organic waste material other than wood waste material, and inorganic waste material including plastic waste material and inorganic waste material other than plastic waste material, in the sorting zone Z_{S}, wherein (i) comprises:
(i.1.1) sorting the solid waste material W in a sorting unit SU1 in Z_{S}, obtaining a mixture M1 comprising the organic solid waste material and a mixture M2 comprising the inorganic solid waste material; and
(i.1.2) sorting the mixture M1 obtained according to (i.1.1) in a sorting unit SU2 in Z_{S}, with SU2 being located downstream of SU1, obtaining a mixture M11 comprising the wood waste material and a mixture M12 depleted in wood waste material compared to M1 comprising the organic waste material other than wood waste material;
(ii) a subsequent stage S2 comprising:
(ii.1) introducing M11 obtained according to (i), as a feed stream F11, into a gasifier in the gas-producing zone Z_{G} and bringing in contact F11 to one or more gasification components in the gasifier, obtaining a stream F1 comprising one or more gases; and
(iii) a subsequent stage S3 comprising:
(iii.1) collecting the mixture M12 obtained according to (i.1.2) in an anaerobic digestion unit in the gas-producing zone Z_{G} and subjecting M12 to anaerobic digestion conditions, obtaining a stream F2 comprising one or more gases.

19. The process of claim 18, wherein sorting according to (i.1.1) is a mechanical or manual sorting, wherein the sorting unit SU1 comprises one or more of magnets, screens, sieves, detection units, and conveyors.

20. The process of claim 18, wherein sorting according to (i.1.2) is a mechanical sorting or manual sorting, wherein the sorting unit S2 comprises one or more of magnets, screens, sieves, detection units, and conveyors.

21. The process of claim 18, wherein S1 further comprising:
(i.2) passing the mixture M11 into a storage unit and storing M11 in said storage unit for a period of time Δt, wherein Δt is in the range of from 1 h to 1 year; and
(i.3) removing M11 from the storage unit prior to (ii).

22. The process of claim 18, wherein S2 further comprises, prior to (i.1), subjecting the wood waste material comprised in M11 obtained according to (i) to a pre-treatment, wherein the pre-treatment comprises one or more of shredding, cutting, pelletizing, milling, crushing, and drying the wood waste material comprised in M11.

23. The process of claim 18, wherein the gasifier is one or more of a fixed bed gasifier, a fluidized bed gasifier, and a slag bath gasifier.

24. The process of claim 18, wherein the one or more gases comprised in F1 provided according to (ii.1) are one or more of H₂, CO, CO₂ and CH₄; and
wherein the one or more gases comprised in F2 provided according to (iii.1) are one or more of CH₄ and CO₂.

25. The process of claim 18, wherein the one or more gasification components in the gasifier according to (ii.1) are selected from the group consisting of air, oxygen (O₂), steam (H₂O), carbon dioxide (CO₂) and a mixture of two or more thereof;
wherein the molar ratio of steam relative to O₂ is in the range of from 0.05:1 to 5:1.

26. The process of claim 18, wherein bringing in contact M11 to the one or more gasification components in the gasifier according to (ii.1) is performed at a temperature in the range of from 500 to 1300° C.;
wherein bringing in contact M11 to the one or more gasification components in the gasifier according to (ii.1) is performed at a pressure in the range of from 0.5 to 50 bar(abs).

27. The process of claim 18, further comprising:
(iv) a subsequent stage S4 comprising:
(iv.1) passing the stream F1 obtained according to (ii) into one or more purification units, obtaining a purified stream F1P comprising one or more gases; and
(iv.2) passing the stream F2 obtained according to (iii) into one or more purification units, obtaining a purified stream F2P comprising one or more gases.

28. The process of claim 27, wherein (iv.2) comprises:
passing the stream F2 obtained according to (iii) comprising CH₄ and CO₂ into one or more purification units, obtaining a purified stream F2P, depleted in CO₂ compared to F2, comprising CH₄.

29. The process of claim 27, wherein (iv) comprises:
(iv.1) passing F1 obtained according to (ii) comprising H₂, CO, CO₂ and CH₄ into a purification unit PU, obtaining a purified stream F1P, depleted in CO₂ compared to F1, comprising H₂, CO and CH₄; and
(iv.2) passing F2 obtained according to (iii) comprising CH₄ and CO₂ into said purification PU, obtaining a purified stream F2P, depleted in CO₂ compared to F2, comprising CH₄;
wherein F1 and F2 are, simultaneously or separately, passed through PU;
wherein PU comprises a CO₂ removal unit, the CO₂ removal unit being one or more of a CO₂ gas separation membrane, an amine absorption unit and Pressure Swing Adsorption (PSA) unit.

30. The process of claim 27, wherein (iv) comprises:
(iv.1) passing F1 obtained according to (ii) into a purification unit PU1, obtaining a purified stream F1P, depleted in one or more impurities compared to F1; and
(iv.2) passing F2 obtained according to (iii) comprising CH₄ and CO₂ into a purification PU2, obtaining a purified stream F2P, depleted in CO₂ compared to F2, comprising CH₄;
wherein PU1 and PU2 are distinct units.

31. The process of claim 27, wherein (iv) further comprises:
(iv.3) subjecting F1P obtained according to (iv.1) to methanation conditions in a methanation unit, obtaining a stream FP comprising CH₄, wherein the concentration of methane in FP>the concentration of methane in F1P.

32. The process of claim 18, further comprising:
(v) a subsequent stage S5 comprising:
(v.1) sorting the mixture M2 obtained according to (i.1.1), obtaining a mixture M21 comprising plastic waste material and a mixture M22, depleted in plastic waste material compared to M2, comprising the inorganic waste material other than plastic waste material; and
(v.2) introducing M21 obtained according to (v.1), as a feed stream F21, into a gasifier in the gas-producing zone Z_{G} and bringing in contact F21 to a feed stream F20 comprising a gasification component in the gasifier, obtaining a stream F3 comprising one or more gases.

33. A production unit for carrying out the process according to claim 18 for producing one or more gases from solid waste material W in a landfill site,
the production unit comprising:
a sorting zone Z_{S} comprising
a sorting unit SU1 for sorting solid waste material;
a sorting unit SU2 for sorting organic solid waste material, SU2 being located downstream of SU1; and
a gas-producing zone Z_{G} comprising:
an anaerobic digestion unit for the digestion of solid waste material and the production of one or more gases;
a gasifier for gasifying carbon-containing solid waste material;
wherein Z_{S} and Z_{G} are located in the landfill site.

34. A process for providing a feedstock for the gas grid, comprising:
performing the process of claim 24, obtaining a methane feedstock; and
providing the methane feedstock to the grid.
